(19) United States
(12) Patent Application Publication
(10) Pub. No.: US 2006/0057455 A1
(43) Pub. Date: Mar. 16, 2006

(54) High-temperature solid electrolyte fuel cell comprising a composite of nanoporous thin-film electrodes and a structured electrolyte

(76) Inventors: Uwe Guntow, Frankfurt (DE); Ellen Ivers-Tiffee, Karlsruhe (DE); Dirk Herbstritt, Durmersheim (DE); Andre Weber, Karlsruhe (DE)

Correspondence Address: EDWARDS & ANGELL, LLP, P.O. BOX 55874, BOSTON, MA, 02205, US

(21) Appl. No.: 10/512,134

(22) PCT Filed: Apr. 15, 2003
(86) PCT No.: PCT/EP03/03936

§ 371 Date: Oct. 13, 2005

(30) Foreign Application Priority Data
Apr. 23, 2002 (DE) 10218074.1
Nov. 4, 2002 (DE) 10251263.9

(51) Int. Cl. H01M 4/86; H01M 8/12; H01M 4/90

(52) U.S. Cl. 429/45; 429/33; 429/30

(57) ABSTRACT

A new high-temperature solid electrolyte fuel cell comprising an electrolyte layer between two electrode layers is obtainable by a process comprising the steps: (i) applying electrolyte particles in a screen printing paste on an unsintered electrolyte substrate and sintering the thus produced structure, (ii) depositing a nano-porous electrode thin layer by a sol-gel-process or an MOD-process on the structure obtained according to step (i) and thermal treatment of the thus coated structure. The fuel cell optionally has an electrolyte boundary layer on the structured screen printed electrolyte layer which is applied by an MOD process.

The invention relates to a new high-temperature solid electrolyte fuel cell (SOFC) comprising a composite of nano-porous thin layer electrodes and a structured electrolyte. In fuel cells, the chemical energy of a fuel is converted directly into electrical energy with high efficiency and minimal emissions. For this purpose, gaseous fuels (for example hydrogen or natural gas) and air are continually fed into the cell.

The basic principle is realized by the spatial separation of the reactants by an ion conductive electrolyte which, on both sides, is in contact with porous electrodes (anode and cathode). In this way, the chemical reaction between the fuel gas and oxygen is split into two part reactions taking place at the electrode/electrolyte interfaces. The electron transfer between the reactants takes place via an external circuit such that in the ideal case (loss free cell) the free enthalpy of reaction is directly converted into electrical energy. In real cells, the efficiency and power density are coupled by the internal resistance which is largely determined by the polarization on resistance of the electrodes. Power density and efficiency can be increased by reducing the internal resistance.

A high-temperature fuel cell usually has an electrolyte of zirconium dioxide (ZrO₂) stabilized with yttrium oxide (Y₂O₃) (YSZ). At temperatures between 600 and 1000° C. and at technically realizable electrolyte densities, this ceramic material shows sufficient conductivity for oxygen ions to achieve an efficient energy conversion.

The electrochemical part reactions take place at the reaction surfaces between the porous electrodes (cathode and anode) and the electrolyte. The main purpose for having porous electrodes is the provision of large reaction surfaces which minimal impairment of gas transport. The larger the reaction surface, referred to as three phase boundary (tpb) between the gas space, electrolyte and electrode, the more current can be transported via the interface at a given polarisation loss. A typical material for the cathode is strontium doped lanthanum manganate ((La, Sr)MnO₃, LSM). A cermet (ceramic metal) of nickel and YSZ serves as anode.

The advantages of high-temperature fuel cells are that, due to the high operating temperatures, various fuels can be reacted directly, that the use of expensive noble metal catalysts becomes redundant and that the operating temperature between 600 and 1000° C. makes it possible to use the loss heat as process steam or in coupled gas and steam turbines.

Disadvantages are degradation processes due to the high operating temperature which result in an increase of the internal resistance of the cell.

Such high-temperature fuel cells are the subject of numerous applications for protective rights such as, for example, DE 43 14 323, EP 0 696 386, WO 94/25994, U.S. Pat. No. 5,629,103, DE 198 36 132, WO 00/42621, U.S. Pat. No. 6,007,683, U.S. Pat. No. 5,753,385.

The object of the present invention is to provide a high-temperature fuel cell with higher long term stability, higher current density and lower polarization resistance.

The invention provides a high-temperature solid electrolyte fuel cell comprising an electrolyte layer between two electrode layers obtainable by a process comprising the steps: (i) applying electrolyte particles in a screen printing paste onto an unsintered electrolyte substrate and sintering the structure thus produced, (ii) depositing a nano-porous thin electrode layer by a sol-gel-process or an MOD-process on the structure obtained in step (i) and thermal treatment of the thus coated structure.

This thermal treatment can take place upon immediate putting into operation of the fuel cell. The heating up of the fuel cell required for this purpose results in a sufficient electrical conductivity of the structure. The formation of undesired pyrochlore phases is avoided by this step. Thus, a separate sintering process becomes redundant in the production of the fuel cell according to the present invention.

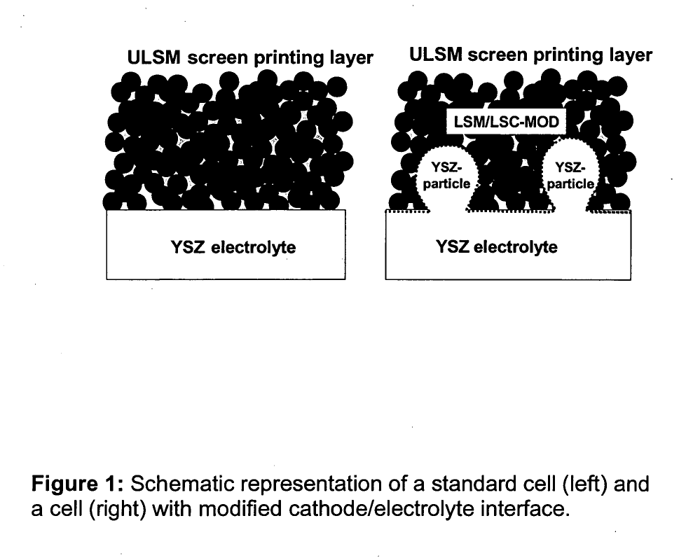

The high-temperature solid electrolyte fuel cell according to the present invention firstly has an improved interface between the electrolyte and electrode layer as compared to fuel cells described in the prior art. In the fuel cell according to the present invention, the effectively usable surface of the electrolyte substrate is increased by a structuring in order to achieve an increase in the electrochemically active three phase boundary. The structured surface is subsequently coated with a nano-porous thin layer electrode which has a layer thickness of 50-500 nm. This layer can be applied by a sol-gel-process or an MOD (Metal Organic Deposition) process (FIG. 1).

Optionally, an electrolyte layer can additionally be applied on the structured screen printed electrolyte layer by an MOD-process. This layer can be applied on the cathode and the anode side of the electrolyte. By means of such an MOD layer, consisting of doped zirconium dioxide (yttrium and scandium doped) or doped cerium oxide (yttrium, gadolinium or samarium doped), negative interactions between electrode and electrolyte can be prevented and the start up operation of the cell can be shortened or even avoided.

For the preparation of this electrolyte boundary layer, the aforementioned components are preferably used in highly pure form. The electrolyte boundary layer is preferably very thin and its preferred thickness is 100 to 500 nm.

The high-temperature solid electrolyte fuel cell according to the present invention has the advantage that, due to the increase of the electrochemically active interface between electrode and electrolyte by means of structuring the electrolyte surface, a reduced surface specific resistance, a higher efficiency at constant surface specific power and a lower electrical load relative to the electrochemically active interface can be achieved. The last mentioned lower electrical load results in reduced degradation of the cell and an increase of the power by a factor of 2 to 3.

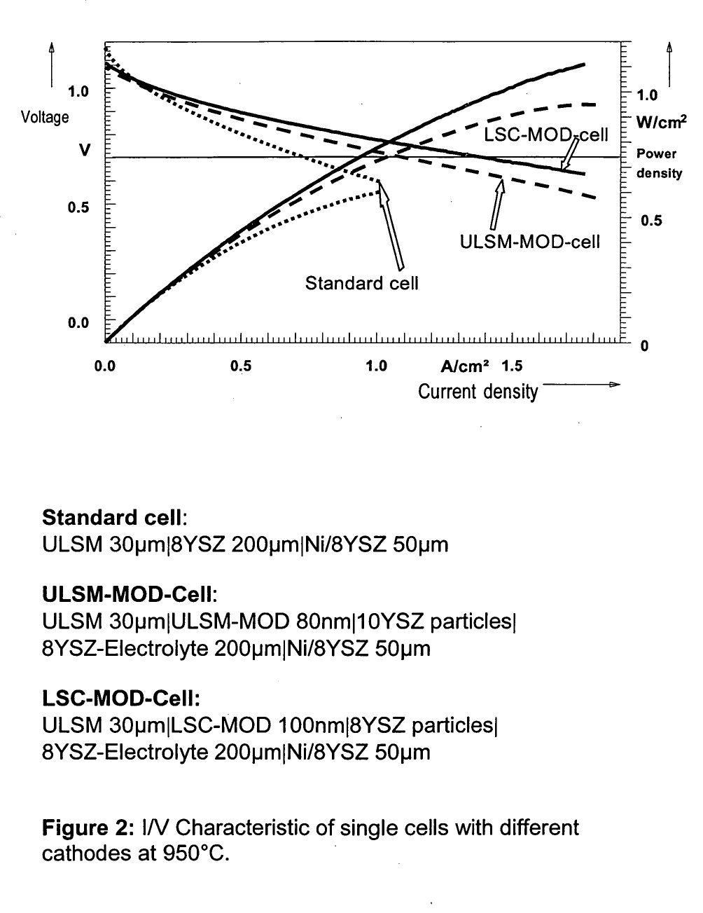

With modified cells, power densities of 1.4 A/cm² at a cell voltage of 0.7 V and energy densities of 1.10 W/cm² are obtained (fuel gas: H₂, 0.5 l/min, oxidation gas: air, 0.7 l/min, electrode surface: 10 cm²). The cathode performance is strongly dependent on the microstructure of the interface and the composition of the MOD layer between the electrolyte surface and the screen printed ULSM layer. Compared to single cells with standard cathodes, an increase of power by 100% at a cell voltage of 0.7 V is achieved by the modification of the cathode (FIG. 2).

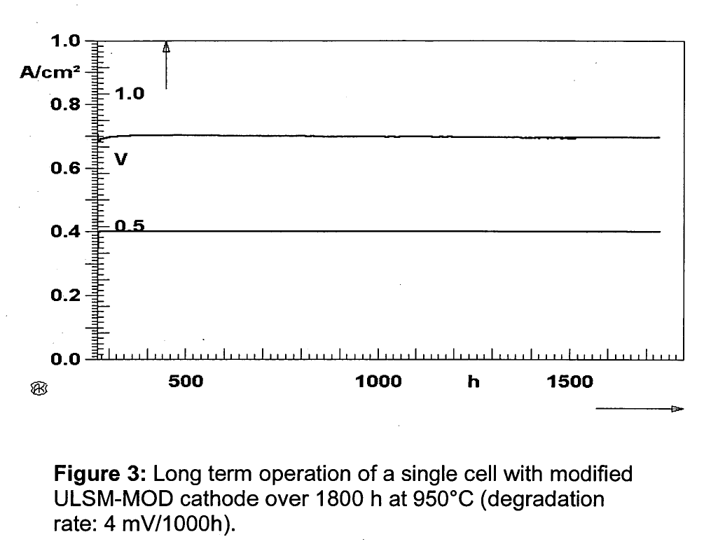

During operation for 1,800 h at 950° C., single cells with modified cathodes at 400 mA/cm² show a markedly lower voltage degradation (4 mV/1,000 h) than standard cells (35 mV/1,000 h). In long term operation, they have a significantly higher stability than cells with standard cathodes (FIG. 3).

Further advantages of the fuel cells according to the present invention are an increase in the surface specific power at constant efficiency and its cost-efficient production because expensive and chemically pure materials need to be employed only at the electrochemically active regions of the interface. By the concept of a structured electrolyte surface according to the present invention, an improved adhesion of the electrode layer on the electrolyte is achieved, which, as mentioned above, prevents degradation by delamination.

In the case of an electrolyte supported cell, the structuring of the electrolyte surface takes place directly upon calendering or, in the case of a cell supported by one of the electrodes or by an electrochemically inactive substrate, by screen printing or spraying.

As electrolyte substrate or supported thin layer electrolyte, there is preferably used a green sheet or a green (unsintered) electrolyte layer of yttrium doped zirconium oxide (of a suitable solid electrolyte). The screen printing paste is applied thereon.

According to a preferred embodiment of the invention, the paste has a solid content in the range of 10 to 30%. Higher solid contents in the screen printing paste result in a reduction of the effective electrolyte surface and, furthermore, in an increase of the average electrolyte thickness. Both result ultimately in a reduction of the electrical performance of an SOFC. For these reasons, the solid content in the screen printing paste must be in the aforementioned range.

Furthermore, it is preferred that the powder fraction of the paste has a particle size distribution in the range of 5 to a maximum of 20 μm.

The structure on the interface is sintered together with the electrolyte. The advantage therein is that only one sintering step is required and that, due to the higher sintering activity of the powder components in the initial state, an improved adhesion of the structure is achieved.

The structuring can take place both on the cathode and the anode side. By different doping in the granules or material combinations in the granules (for example different yttrium doping in zirconium dioxide, scandium doped zirconium dioxide (SzSZ), gadolinium doped cerium oxide (GCO) etc.) and in the substrate (yttrium doped zirconium dioxide, doped CeO₂ or scandium doped zirconium dioxide (SzSZ) on tetragonal (TZP) zirconium dioxide) lower ohmic losses and an improvement of the material stability are achieved and the use of highly pure costly electrolyte materials can be limited to the interface.

As mentioned above, the structuring of the electrolyte surface results in an improved adhesion of the electrode. Thus, a delamination of the electrode layer across large areas is prevented (by interlocking the electrode and electrolyte).

Furthermore, the increase of the electrochemically active interface between cathode and electrolyte results in a reduction of the polarization resistance.

Moreover, the granule size of the particles applied as the structuring can be adapted to individual requirements. The structuring can be effected with small or large as well as with small and large granules.

Additional large granules, whose diameter is in the range of the thickness of the electrode layer, improve the support function, reduce the densification of the electrode under the contact bars in the stack because the sintering activity of the electrolyte material is much smaller than that of the cathode and anode materials.

In the production of the fuel cell according to the invention, the deposition of a nano-porous electrode thin layer takes place by a sol-gel-process or MOD-process on the electrolyte surface structured as described above.

For the synthesis of the (La₁₋ₓ—Srₓ)M_{T}O₃ precursors with M_{T}=Mn, Co, the individual propionates of La, Sr, Co and Mn are produced first. These are obtained as solids by reacting La₂(CO₃)₃, elemental strontium, Co(OH)₂ or Mn(CH₃COOH)₂ with excess propionic acid and in the presence of propionic acid anhydride. By means of these building blocks, it is possible to obtain any desired chemical composition and any desired final stochiometry of the cathode MOD layer. The individual building blocks can be stored for years. It is also possible to replace or complement some components by other carboxylates, for example acetate, or by diketonates, for example in form of the acetyl acetonates, and thus to provide further building blocks.

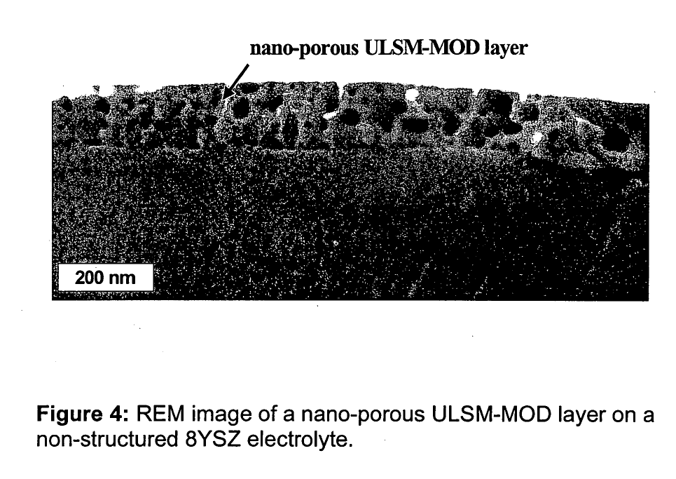

For the production of a coating solution with the composition La_{0.75}Sr_{0.20}MnO₃, the precursors are dissolved in proprionic acid in the corresponding stochiometric ratios. The solid content is typically between 12 and 14 mass % with respect to the oxide. The composition of the coating solutions can be controlled by means of ICP-AES (Inductively Coupled Plasma Atomic Emission Spectroscopy) and the solid content can be controlled thermogravimetrically. The coating solutions can be stored at room temperature for several months. Subsequently, the layers are applied from the liquid phase by spinning (2,000 rpm for 60 sec) or dipping and are stored at 170, 700 and 900° C., respectively, for 15 min. The thickness of a single coating is 80 to 100 nm. Greater thicknesses can be produced by corresponding repetition of the coating procedure (FIG. 4).

The nano-porous electrode thin layers deposited by the sol-gel-process or MOD-process described above have the advantage that the nano-porosity throughout the MOD layer enables a high number of three phase boundaries.

As materials for the cathodes there may be used electronic conductor or mixed conductor metal oxides, in particular, perowskites of the composition (L₁₋ₓ-ₓAₓ)M_{T}O₃ wherein A=Sr, Ca, M_{T}=Cr, Mn, Fe, Co, Ni. Examples for such materials are doped LaMnO₃, doped LaCoO₃ and doped LaFeO₃.

Material systems for the anode are, for example, Ni, Ni/YSZ, Ni/doped CeO₂ and doped CeO₂.

As mentioned above, the use of such nano-porous MOD electrode thin layers in the fuel cell according to the present invention results in a higher number of three phase boundaries in predominantly electron conducting materials.

Moreover, the stochiometry and the chemistry of the metal oxides employed, in particular, of the perowskites, can be varied.

Furthermore, due to the low layer thickness and the low process temperatures in the production, it becomes possible to employ materials which are otherwise chemically and thermomechanically incompatible (for example strontium doped lanthanum cobaltate on YSZ). A further advantage of the nano-porous MOD electrode thin layers is their stability under the operating conditions of the fuel cell.

The nano-porous MOD electrode thin layers can also be used as intermediate layers. For example, an MOD thin layer electrolyte of 10 mol % Y₂O₃ or Sc₂O₃ doped ZrO₂ (10YSZ/10ScSZ) can be applied to an electrolyte substrate of standard materials (3 or 8 mol % Y₂O₃ doped ZrO₂). This thin layer electrolyte, which has higher purity and ionic conductivity, can be produced on the cathode and/or anode side. The MOD electrolyte layer as intermediate layer makes it possible to limit the use of a highly pure but costly electrolyte material to the region of the electrode/electrolyte interface and thus results in reduced ohmic losses by current constriction as well as to lower polarization resistances due to the formation of secondary phases. The purity requirements of the supporting electrolyte substrate are lowered and the use of cheaper starting materials becomes possible.

### The invention will be further illustrated by the following examples and the appended figures.

FIG. 1 shows a schematic representation of a standard cell (left) and a cell according to the present invention (right) with modified cathode/electrolyte interface.

FIG. 2 shows the current/voltage (I/V) characteristic of single cells with different cathodes at 950° C.

FIG. 3 describes the current density as a function of time in the long term operation of a single cell with modified ULSM-MOD cathode over 1,800 hours at 950° C. (degradation rate: 4 mV/1,000 h).

FIG. 4 shows an REM image of a nano-porous ULSM-MOD layer on a non-structured 8YSZ electrolyte.

### EXAMPLE 1

Single cells with modified ULSM cathodes are produced as follows:

8YSZ particles are applied to 8YSZ green sheets (8YSZ: Tosoh TZ-8Y) by a screen printing process. The particle content in the screen printing paste is selected such that an surface increase by about 25% is achieved. This structured electrolyte is sintered for one hour at 1,550° C. On the opposite side, a 30-40 μm thick Ni/8YSZ cermet is applied by screen printing as an anode and is sintered for 5 hours at 1,350° C.

Subsequently a single cathode MOD layer of the composition La_{0.75}Sr_{0.20}MnO₃ (ULSM) is applied on the structured side of the electrolyte by spinning and sintered respectively for 15 minutes at 170, 700 and 900° C. The thickness of this layer is about 80 nm. Onto this MOD cathode, a 30-40 μm thick ULSM layer is printed by screen printing.

### EXAMPLE 2

Single cells with modified LSC cathodes are produced as follows:

8YSZ particles are applied to 8YSZ green sheets (8YSZ: Tosoh TZ-8Y) by a screen printing process and sintered for one hour at 1,550° C. On the opposite side, a 30-40 μm thick Ni/8YSZ cermet is applied by screen printing as an anode and is sintered for 5 hours at 1,300° C.

Subsequently, a single cathode MOD layer of the composition La_{0.50}Sr_{0.50}CoO₃ (LSC) is applied to the structured side of the electrolyte by spinning and sintered respectively for 15 minutes at 170, 700 and 900° C. The thickness of this layer is about 100 nm. Onto this MOD cathode, a 30-40 μm thick ULSM layer is printed by screen printing.

1. High-temperature solid electrolyte fuel cell comprising an electrolyte layer between two electrode layers obtainable by a process comprising the steps:
(i) applying electrolyte particles in a screen printing paste onto an unsintered electrolyte and sintering the thus produced structure,
(ii) depositing a nano-porous electrode thin layer by a sol-gel-process or an MOD-process on the structure obtained according to step (i) and the thermal treatment of the thus coated structure.

2. High-temperature solid electrolyte fuel cell according to claim 1 wherein an electrolyte of yttrium or scandium doped ZrO₂ is used in step (i).

3. High-temperature solid electrolyte fuel cell according to claim 1 wherein a paste comprising doped zirconium dioxide (yttrium or scandium doped) or doped cerium oxide (yttrium, gadolinium or samarium doped) is used as screen printing paste.

4. High-temperature solid electrolyte fuel cell according to claim 3 wherein the screen printing paste has a solid content of 10 to 30 wt.-%.

5. High-temperature solid electrolyte fuel cell according to claim 3 wherein the granule size distribution of the powder fraction of the paste is in the range of 5 to 20 μm.

6. High-temperature solid electrolyte fuel cell according to claim 1 wherein electrolyte boundary layer on the structured screen printed electrolyte layer obtained according to step (i), which is applied by an MOD process.

7. High-temperature solid electrolyte fuel cell according to claim 1 wherein a layer comprising strontium doped lanthanum cobaltate (LSC) La_{0.50}Sr_{0.50}CoO₃ is deposited in step (ii).

8. High-temperature solid electrolyte fuel cell according to claim 1 wherein a layer comprising substochiometric strontium doped lanthanum manganate (ULSM) La_{0.75}Sr_{0.20}MnO₃ is deposited in step (ii).

9. High-temperature solid electrolyte fuel cell according to claim 7 wherein the solid content of the LSM coating solution and the solid content of the ULSM coating solution is 12-14 mass %, respectively.

10. A process to provide a fuel cell comprising:
(i) applying electrolyte particles in a screen printing paste onto an unsintered electrolyte and sintering the thus produced structure,
(ii) depositing a nano-porous electrode thin layer by a sol-gel-process or an MOD-process on the structure obtained according to step (i) and the thermal treatment of the thus coated structure.
